(19) United States
(12) Patent Application Publication
(10) Pub. No.: US 2017/0317826 A1
(43) Pub. Date: Nov. 2, 2017

(54) SERVER DEVICE, CLIENT DEVICE, COMPUTER READABLE MEDIUM, SESSION MANAGING METHOD, AND CLIENT SERVER SYSTEM

(71) Applicant: MITSUBISHI ELECTRIC CORPORATION, Tokyo (JP)

(72) Inventor: Takashi SAKAKURA, Tokyo (JP)

(73) Assignee: Mitsubishi Electric Corporation, Tokyo (JP)

(21) Appl. No.: 15/524,533

(22) PCT Filed: Nov. 14, 2014
(86) PCT No.: PCT/JP2014/080229

§ 371 Date: May 4, 2017

(51) Int. Cl. H04L 9/30; H04L 29/06

(52) U.S. Cl. CPC H04L 9/30; H04L 65/1069; H04L 63/061; H04L 67/42

(57) ABSTRACT

A session managing unit connects an interprocess communication between a server device and a client device, and receives a session start message (400) including the first server program identifier that identifies the first server program and the second server program identifier that identifies the second server program, from the client device. When the session start message (400) is received, the session managing unit connects an interprocess communication between a process of the first server program and a process of the second server program.

### TECHNICAL FIELD

The present invention relates to execution of a plurality of server programs.

### Background Art

In the context of conspicuous development of computers for daily use, the computer system has varied from a batch processing system to a TSS. TSS is an abbreviation for Time Sharing System. Further, the operation of the computer system has varied from an operation to connect to a mainframe computer of a workstation having the IBM 3270 terminal emulation function to an operation of a backbone system using a UNIX server having a fault tolerance. However, in our country, mainframes are still the mainstream. IBM and UNIX are registered trademarks.

Innovation of digital technologies has progressed not only in computers, but also in communication systems of mobile communication and fiber-optic communication, etc., and large-capacity and high-speed communication has been made possible. Then in the near future, an IP-based network is predicted to substitute for the conventional PSTN. IP is an abbreviation for Internet Protocol, and PSTN is an abbreviation for Public Switched Telephone Network.

The processing performance of terminals have also improved tremendously. The processing performance of mobile terminals called smartphones has also improved tremendously including an advanced 3D capability, not to speak of PCs. PC is an abbreviation for Personal Computer, and 3D is an abbreviation for Three Dimensional.

In these contexts, cloud computing has become conspicuous. Cloud computing is a service for an internet distributor and an internet search provider to rent computer resources by the hour. The reality of a cloud is a data center composed of computer clusters.

A data center operated in a company is called a private cloud. Meanwhile, data centers charged by the hour operated in a plurality of locations are called a public cloud. There are multipoint-based data centers performing data synchronization connected by a submarine ground network, and data registered, updated or deleted in a data center in one location can be also used in other data centers. Then, service users can use services conveniently wherever they are in the world. Further, service providers and service users can expand or degenerate services as necessary.

In the public cloud, it is desired to realize data protection, simultaneous use of a plurality of services and use of services in a disconnected state. Further, it is desired to provide advanced convenience with limited human resources.

Patent Literature 1 proposes use of inetd realized on a UNIX system in a non-connected state. The result of program execution in the non-connected state can be obtained by connecting to a server. UNIX is a registered trademark.

### CITATION LIST

### Patent Literature

Patent Literature 1: JP 2013-200702 A

### SUMMARY OF INVENTION

### Technical Problem

The present invention is aimed at making it possible to execute a plurality of server programs designated by a client device in an associated manner.

### Solution to Problem

A server device according to the present invention includes a session managing unit, wherein
the session managing unit receives a session start message describing a dependency including two and more services to be used, from a client device,
and generates processes of the two and more services to be used, and a communication connection between the services, according to the session start message.

### Advantageous Effects of Invention

According to the present invention, it is possible to connect an interprocess communication of each process in a plurality of server programs designated by a client device. This enables execution of the plurality of server programs designated by the client device in an associated manner.

### BRIEF DESCRIPTION OF DRAWINGS

FIG. 1 is a diagram describing a configuration example of a client server system 100 in the first embodiment;

FIG. 2 is a configuration diagram of functions of a server device 200 in the first embodiment;

FIG. 3 is a diagram describing one example of a server program group 300 in the first embodiment;

FIG. 4 is a diagram describing one example of a session start message 400 in the first embodiment;

FIG. 5 is a flowchart describing operations of the server device 200 in the first embodiment;

FIG. 6 is a diagram describing one example of a state of the server program group 300 in the first embodiment;

FIG. 7 is a diagram describing one example of a state of the server program group 300 in the first embodiment;

FIG. 8 is a diagram on hardware configuration of the server device 200 in the first embodiment;

FIG. 9 is a diagram describing one example of a session termination message 500 in the second embodiment; and

FIG. 10 is a flowchart describing operations of the server device 200 in the second embodiment.

### DESCRIPTION OF EMBODIMENTS

### First Embodiment

An embodiment will be described wherein a client device designates a plurality of server programs, and a server device executes the designated plurality of server programs in an associated manner.

### Explanation of Configuration

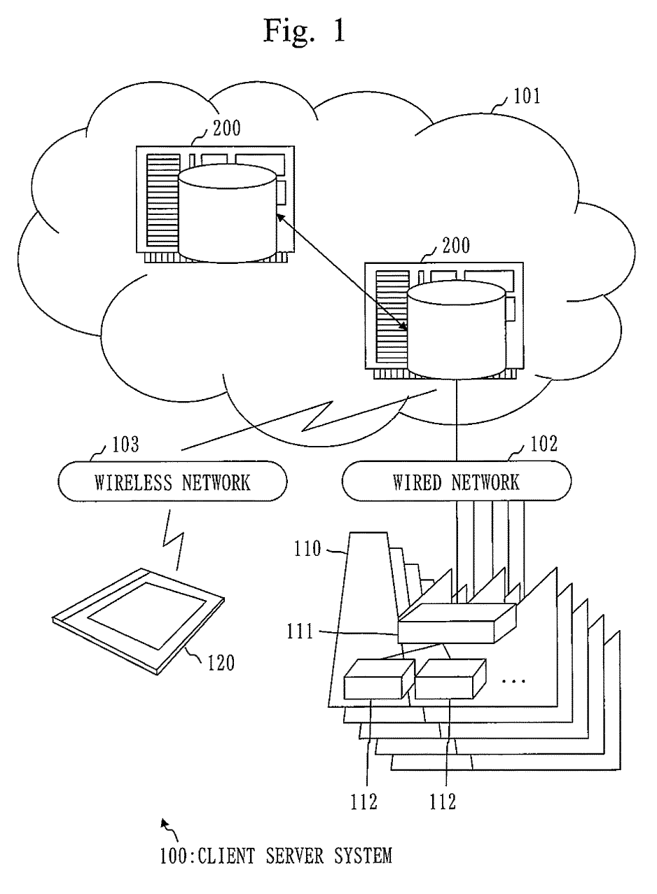

FIG. 1 is a diagram describing a configuration example of a client server system 100 in the first embodiment.

The configuration example of the client server system 100 in the first embodiment will be described based on FIG. 1.

The client server system 100 includes a cloud 101. The cloud 101 is also referred to as a cloud system or a cloud computing system.

The cloud 101 includes a plurality of server devices 200. Each server device 200 may be either a real machine, or a virtual machine executed by a real machine.

For example, the plurality of server devices 200 are several tens of data centers, which are located around the world and mutually connected by an exclusive line. The data centers are computers that manage data. All the data centers share the data. That is, addition, change and deletion of data occurred at either of the data centers are reflected in all the other data centers by a data synchronization technique.

The client server system 100 includes a plurality of factories 110 and one and more operation terminals 120. Each factory 110 is a facility that produces products, including a machine for producing products.

Each factory 100 is equipped with a gateway device 111 and one and more controllers 112 that connect to the gateway device 111. The gateway device 111 is constantly connected to the server device 200. The controllers 112 are computers that control a machine that operates in the factory 110.

The gateway device 111 connects to the server device 200 via a wired network 102, and the operation terminal 120 connects to the server device 200 via a wireless network 103 such as a mobile communication network or a wireless LAN, and so on. However, the gateway device 111 and the operation terminal 120 may connect to the server device 200 in another connection form. LAN is an abbreviation for Local Area Network.

The gateway device 111, the controllers 112 and the operation terminal 120 are examples of the client device.

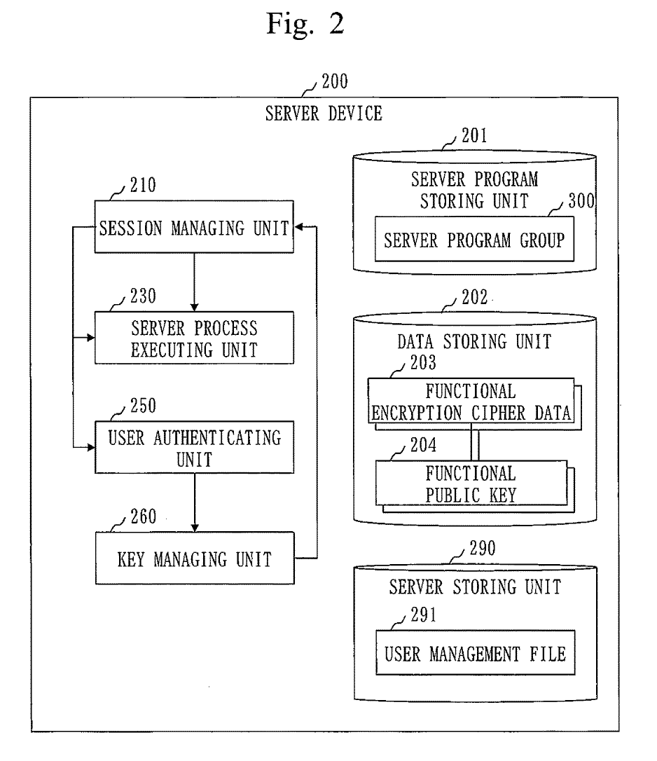

FIG. 2 is a configuration diagram of functions of the server device 200 in the first embodiment.

The function configuration of the server device 200 in the first embodiment will be described based on FIG. 2. However, the function configuration of the server device 200 may not be the same function configuration as the function configuration described in FIG. 2.

The server device 200 includes a session managing unit 210, a server process executing unit 230, a user authenticating unit 250 and a key managing unit 260.

The server device 200 includes a server program storing unit 201, a data storing unit 202 and a server storing unit 290.

The session managing unit 210 executes an interprocess communication between the client device and the server device. A process is a run unit of a program, which means a program in an executable state.

The session managing unit 210 receives a session start message from the client device. The session start message includes the first server program identifier that identifies the first server program and the second server program identifier that identifies the second server program.

When the session start message is received, the session managing unit 210 connects a communication between the first server and the second server based on the session start message.

The session managing unit 210 manages a process that operates in the server device 200 and a context for executing the process. The context includes state information indicating a state of the process.

For example, the session managing unit 210 generates an execution context. The execution context is a context for executing a server process. The execution context is for accessing data managed by a plurality of user authorities. For example, the managed data is encrypted with a public key in a functional encryption system, and the execution context includes a public key (re-encryption key) for decrypting the re-encryption. The execution context, or the server process, enables reference of data necessary for the execution by the re-encrypted public key (re-encryption key). However, other types of encryption systems can be applied to encryption of the managed data.

The server process executing unit 230 executes the first server program and the second server program by executing the server process. The server process executing unit 230 may be read as a server program executing unit.

The user authenticating unit 250 performs authentication of a user who uses a client device that accesses the server device 200.

The key managing unit 260 generates a new shared secret key (one example of a new common key), and generates an encrypted new shared secret key (one example of an encrypted new common key) by encrypting the new shared secret key using a present shared secret key (one example of a present common key). The new common key is a common key used in an interprocess communication between the server device and the client device. The present common key is a common key used in the interprocess communication between the server device and the client device. The common key is an encryption key and a decryption key in a common key cryptosystem.

The encrypted new common key is transmitted to the client device by the session managing unit 210.

The server program storing unit 201 stores the server program group 300 composed of a plurality of server programs.

Each server program is a service program that realizes a service provided to a client device. Each server program is one example of the first server program and the second server program.

The server program is loaded in a memory and put into an operating status by the CPU starting processing based on a program counter and a stack pointer.

The data storing unit 202 stores a plurality of functional encryption cipher data 203. Each of the functional encryption cipher data 203 is made to correspond to a functional public key 204.

The functional encryption cipher data 203 is data encrypted using the functional public key 204, and is decrypted using a functional secret key of a user having an access authority, satisfying decryption conditions. Updating, insertion and deletion of the data encrypted using the functional public key 204 is performed by using the functional public key 204. The functional public key 204 is a public key in a functional encryption system, and the decryption conditions are set to the functional public key 204. The functional secret key is a secret key in a functional encryption system, and an access authority is set to the functional secret key. The data encrypted using the functional public key 204 is plaintext data related to the client device. When data is encrypted with a public key for an administrator authority, the encrypted data cannot be decrypted with a secret key of a user if the user tries to refer to the encrypted data. Then, by use of a re-encryption key using a proxy re-encryption technique, reference of a specific document based on a specific authority is made possible. Especially, the functional encryption is suitable for this function. For example, the data encrypted with use of the functional public key 204 is data owned by the controller 112.

For example, the data storing unit 202 is a distributed shared memory. The functional encryption cipher data 203 is read into the distributed shared memory from a storage and processed, and the processed functional encryption cipher data 203 is stored in the storage from the distributed shared memory.

For example, the data storing unit 202 and the memory of the controller 112 have functions that updates of the stored data are mutually reflected.

For example, data accumulated in the storage is stored in the data storing unit 202, data added or changed in the data storing unit 202 is accumulated in the storage, and data deleted from the data storing unit 202 is deleted from the storage.

The server storing unit 290 stores data that the server device 200 uses, generates, or inputs and outputs.

For example, the server storing unit 290 stores a user management file 291.

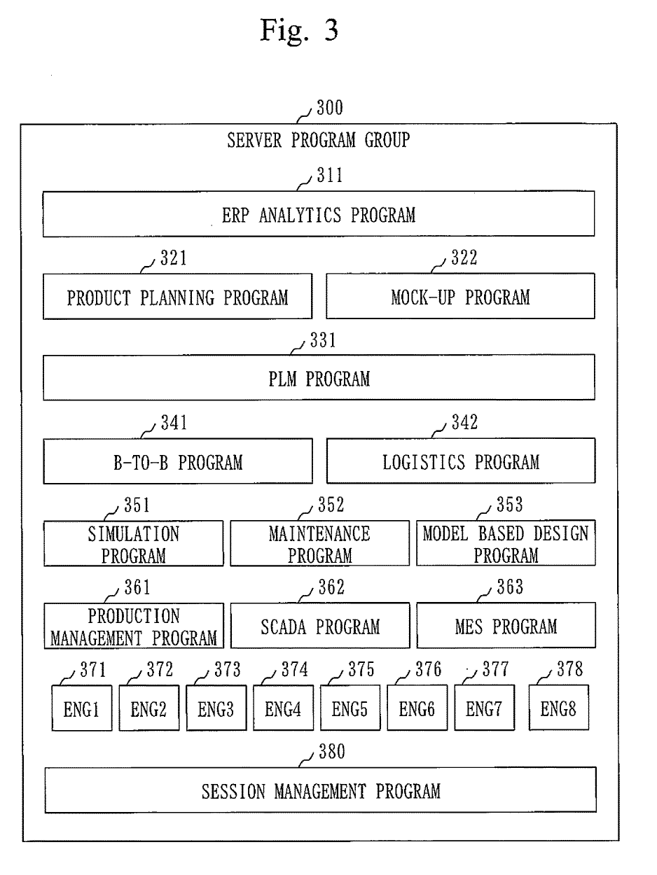

FIG. 3 is a diagram describing one example of the server program group 300 in the first embodiment.

One example of the server program group 300 in the first embodiment will be described based on FIG. 3.

An ERP analytics program 311 is a program for analyzing data related to the factories 110, such as operating status data, PLM data, procurement and shipping data, production management data and MES data, etc.

ERP is an abbreviation for Enterprise Resource Planning.

PLM is an abbreviation for Product Life Cycle Management.

MES is an abbreviation for Manufacturing Execution System.

A product planning program 321 and a mock-up program 322 are programs to improve the degree of completion of a product mock-up based on feedback such as an analysis result by the ERP analytics program 311, a model design result by a model based design program 353, and product management data of the factories 110, etc.

A PLM program 331 is a program for managing sharing of design data, production management, product maintenance and re-use of a product at the end of its life, etc. based on the model design result by the model based design program 353, etc. The PLM program 331 becomes a central core of management in manufacturing.

A B-to-B program 341 and a logistics program 342 are programs for performing selection of a supplier, management of production performance, management of the annual revenue, management of the annual expenditure, management of receipt of goods from a supplier, custody of inventory, logistics management of product delivery and accounting service. B to B is an abbreviation for Business to Business, which means commerce transaction between companies.

A simulation program 351 is a program for performing several types of simulation.

A maintenance program 352 is a program for performing several types of maintenance.

The model based design program 353 is a program for performing model design.

A production management program 361 is a program for managing production performance.

A SCADA program 362 is a program for monitoring an operating status. SCADA is an abbreviation for Supervisory Control And Data Acquisition.

An MES program 363 is a program for assigning a production plan and recipe data to the factories 110.

An ENGx in the diagram means the x-th engineering program. Each engineering program is implemented as a server program; hence each engineering program can use mutual functions.

Eight engineering programs from the first engineering program 371 through the eighth engineering program 378 are programs for performing generation and editing of a control program. The control program is a program for controlling the controller 112 or the operation terminal 120, etc. By the engineering programs being executed, the control program for the controller 112, the control program for an IO unit, and the control program for the operation terminal 120, etc. are programmed. IO is an abbreviation for Input and Output.

Eight engineering programs operate cooperatively. For example, change in a certain control program is reflected in the control program of the operation terminal 120.

Eight engineering programs function as mutually different engineering tools. For example, eight engineering programs include an engineering program for field control, an engineering program for motion control, and an engineering program for an NC machine, etc. NC is an abbreviation for Numerical Control.

A session management program 380 is a program including a function to manage an interprocess communication between the server device and the client device, and a function to manage an interprocess communication between the first server process and the second server process.

A process of the session management program 380 is executed by the session managing unit 210, and processes of the other server programs (311 through 378) are executed by the server process executing unit 230.

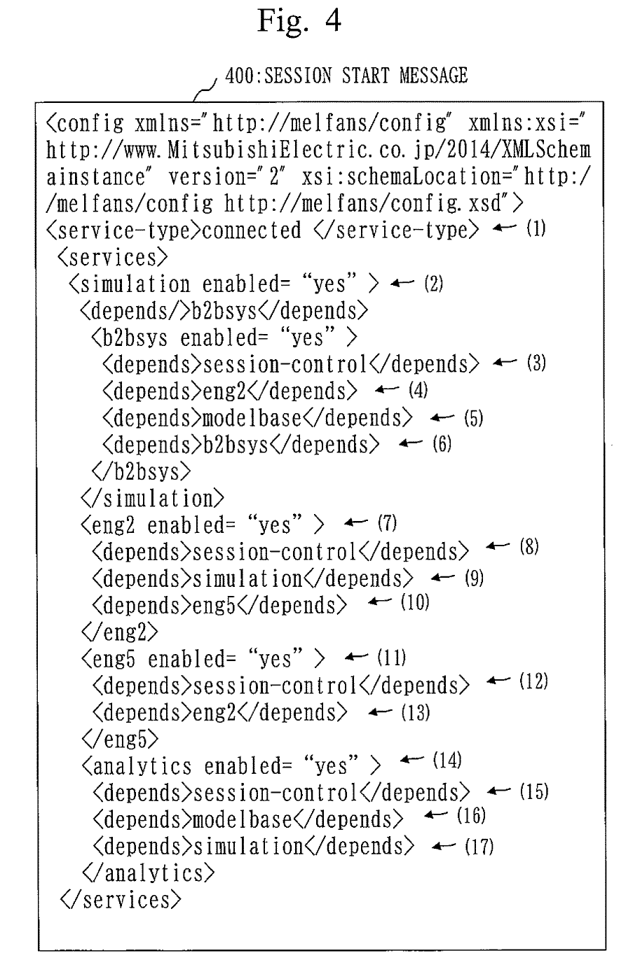

FIG. 4 is a diagram describing one example of the session start message 400 in the first embodiment.

One example of the session start message 400 in the first embodiment will be described based on FIG. 4.

In FIG. 4, the session start message 400 is indicated as text data; however, an actual session start message 400 is binary data. Further, the same is true on the other messages.

The session start message 400 includes lines of (1) through (17).

The line of (1) includes a string of “service-type” and a string of “connected.”

“service-type” is a message type identifier that identifies a type of a message. “connected” is a session start identifier meaning connection of an interprocess communication between the service device and a client device.

The lines of (2), (9) and (17) include “simulation” as a program identifier of the simulation program 351.

The lines of (3), (8), (12) and (15) include “session-control” as a program identifier of the session management program 380.

The lines of (4), (7) and (13) include “eng2” as a program identifier of the second engineering program 372.

The lines of (5) and (16) include “modelbase” as a program identifier of the model based design program 353.

The line of (6) includes “b2bsys” as a program identifier of the B-to-B program 341.

The lines of (10) and (11) include “eng5” as a program identifier of the fifth engineering program 375.

The line of (14) includes “analytics” as a program identifier of the ERP analytics program 311.

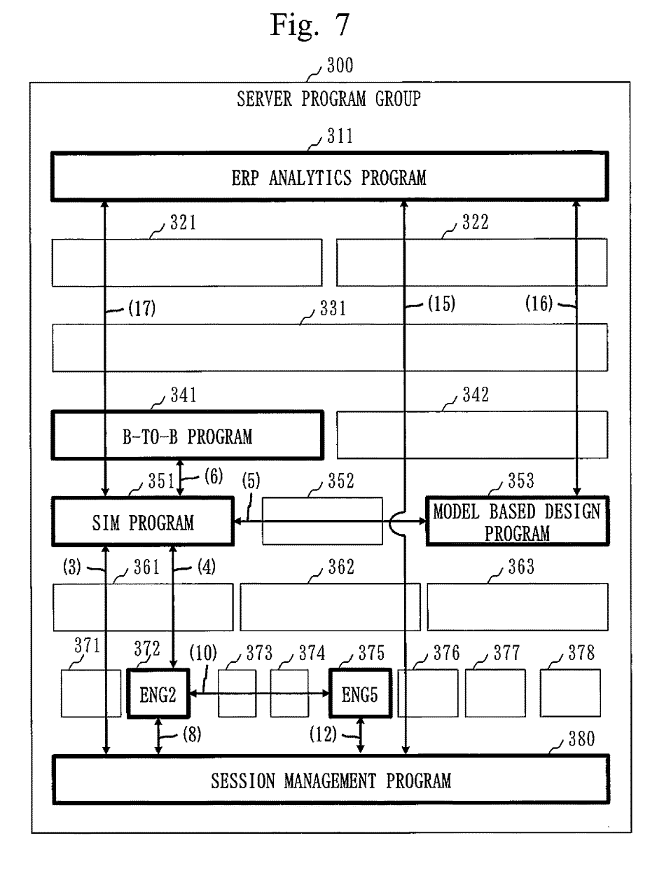

The session start message 400 in FIG. 4 is one example of a message written in an XML language on a case wherein product specifications are changed based on a result of analysis by the ERP analytics program 311. The session start message 400 is used in a case as follows. In the following explanation, processing of a user is performed using the operation terminal 120. The connection relation of each server of the program server group in FIG. 3 is described also in FIG. 7 based on the session start message 400.

When a connection is made to the program server group in FIG. 3, the user identifies an address to the program sever group and executes connection to the session management program 380 using the session start message 400 in FIG. 4, from the first line to the fifth line indicated as (1).

Next, a connection to the simulation program 351, which can perform an interlocking operation with the ERP analytics program 311, is made by the seventh line indicated as (2) in FIG. 4, and further, by the eighth and ninth lines, activation of the B-to-B program 341 as a next operation is performed.

Next, by the description from the tenth line through the 13^{th} line in FIG. 4, the B-to-B program 341 makes the session management program 380, the second engineering program 372 and the model based design program 353 cooperate.

In this manner, it becomes possible to perform design change by the B-to-B program 341 based on information that has undergone the process of the ERP analytics program 311.

Further, the simulation program 351 verifies the design change by simulation, and model design is performed by the model based design program 353 using the verification result. By this model design, change in steps of product assembling and change in steps of part cutting and processing derive. Then, with the change in the steps of product assembly, change in the control program of the controller 112 derives, and with the change in the steps of part cutting and processing, change in the control program of the NC machine derives.

The ERP analytics program 311 verifies whether the requirements of change in the specifications are met based on the data of model design. When it is determined that the requirements of change in specifications are met, it becomes possible for the user to designate the second engineering program 372 as an engineering tool for a controller in order to change the control program of the controller 112.

Further, from the 16^{th} line through the 19^{th} line in the session start message 400 in FIG. 4, it is indicated that the second engineering program 372 works in cooperation with the session management program 380 and the simulation program 351. The simulation program 351 can operates simultaneously with the fifth engineering program 375 and the ERP analytics program 311.

Thus, the user designates the fifth engineering program 375 as an engineering tool for performing control terminal design in order to change the control program of the NC machine based on change in the specifications. The ERP analytics program 311 verifies whether the requirements of change in the specifications are met based on data of the control terminal design. If there is no problem, the fifth engineering program 375 updates the control program of the NC machine and the control program of the operation terminal 120 for monitoring the NC machine.

After the control programs are changed, the user confirms that there is no problem by performing simulation verification again, releases the session of the server device 200 and completes the operation.

Here, for the simulation program 351 which can operate simultaneously with the ERP analytics program 311, it is indicated in the 24^{th} to 27^{th} lines denoted as (14) to (17) in the session start message 400 in FIG. 4 that the simulation program 351 works in cooperation with the model based design program 353 and the simulation program 351 for the ERP analytics program 311.

Thus, by the session start message 400 wherein a service configuration is described being transmitted on establishing the session, it is possible to open a plurality of sessions for a plurality of server programs designated as the service configuration. The service configuration is what to prescribe the plurality of server programs that provide services users want to use.

In this manner, it is possible for the plurality of server programs dependent on one another to operate in a coordinated manner, and to offer high convenience to the users.

### Explanation of Operations

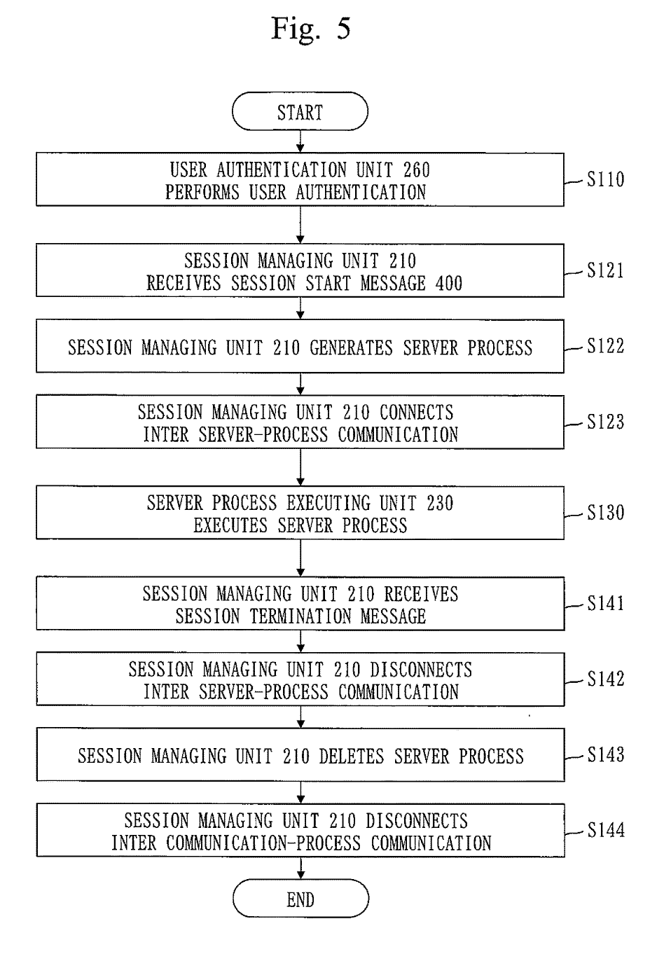

FIG. 5 is a flowchart describing operations of the server device 200 in the first embodiment.

The operations of the server device 200 in the first embodiment will be explained based on FIG. 5. However, the operations of the server device 200 may not be the same as the operations described based on FIG. 5.

S110 is one example of an authentication request message receiving processing, a user authentication processing, an encrypted new common key generating processing, the first session connecting processing and an authentication response message transmitting processing.

In S110, the session managing unit 210 receives an authentication request message transmitted from the operation terminal 120. The authentication request message includes a user identifier and a password. The user identifier and the password are encrypted with a shared secret key. When it is performed via an Web browser of the client, the authentication request message is transmitted to a service port of the session managing unit 210 identified by a port number 80.

The user authenticating unit 250 determines whether a user identifier the same as the user identifier included in the authentication request message is included in the user management file 291. When it is determined that the appropriate user identifier is included in the user management file 291, the user authenticating unit 250 determines whether an appropriate password is the same as a password included in the authentication request message. The appropriate password is a password associated with the appropriate user identifier among passwords included in the user management file 291. When the appropriate password is the same as the password included in the authentication request message, the user authenticating unit 250 authenticates the user. In a case wherein the user is authenticated, a shared secret key associated with the appropriate user identifier among shared secret keys included in the user management file 291 is referred to as an appropriate present shared secret key.

When the user is authenticated, the key managing unit 260 generates a new shared secret key, and encrypts the new shared secret key using the appropriate present shared secret key. The key managing unit 260 updates the appropriate present shared secret key to the new shared secret key. The session managing unit 210 connects an interprocess communication between the server device 200 and the operation terminal 120. However, the key managing unit 260 may regularly update a shared secret key.

The session managing unit 210 transmits an authentication response message including the encrypted shared secret key to the operation terminal 120.

The operation terminal 120 receives the authentication response message, and the encrypted shared secret key included in the authentication response message is decrypted to a new shared secret key using the present shared secret key stored in the operation terminal 120.

After this, contents of various types of messages communicated through the interprocess communication between the server device 200 and the operation terminal 120 are encrypted and decrypted with the new shared secret key. As for encryption and decryption of the contents of various types of messages, the explanation is omitted hereinafter.

After S110, the processing proceeds to S121.

Here, when a user is not authenticated in S110, the session managing unit 210 transmits an authentication response message indicating that the user is not authenticated to the operation terminal 120. Then, the processing from S121 onwards is not executed, and the operation of the server device 200 is terminated. As for the flow of the processing when the user is not authenticated, the graphic representation is omitted.

S121 is one example of a session start message receiving processing.

In S121, the session managing unit 210 receives the session start message 400 transmitted from the operation terminal 120.

After S121, the processing proceeds to S122.

S122 is one example of a server process generating processing and an execution context generating processing.

In S122, the session managing unit 210 generates a server process and an execution context based on the session start message 400.

The generated server process is a process of a server program identified by a server program identifier included in the session start message 400.

The generated execution context is a context for executing the generated server process, including a re-encryption key and the new shared secret key. Further, the generated execution context includes a session identifier identifying the interprocess communication connected in S110 and the user identifier identifying the user authenticated in S110, etc.

After S122, the processing proceeds to S123.

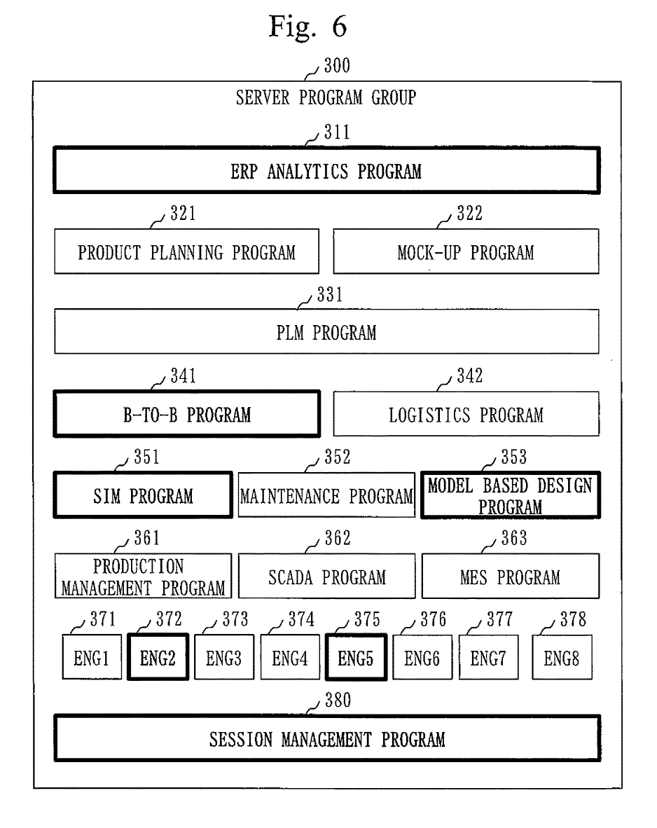

FIG. 6 is a diagram describing one example of a state of the server program group 300 in the first embodiment.

In FIG. 6, the server programs surrounded by thick borders are server programs in an executable state based on the session start message 400 in FIG. 4.

The server program group 300 in the executable state based on the session start message 400 in FIG. 4 is in a state as described in FIG. 6.

S123 (see FIG. 5) is one example of a session connecting processing.

In S123, the session managing unit 210 connects an interprocess communication between the server processes generated in S122 based on the session start message 400.

After S123, the processing proceeds to S130.

FIG. 7 is a diagram describing one example of a state of the server program group 300 in the first embodiment.

In FIG. 7, the server programs surrounded by thick borders are server programs in an executable state based on the session start message 400 in FIG. 4, that is, server processes.

In FIG. 7, directional lines mean connection of interprocess communications between the server processes. The numbers in parentheses attached to the directional lines correspond to the numbers in parentheses indicated in FIG. 4.

When the interprocess communications between the server processes are connected based on the session start message 400 in FIG. 4, the server program group 300 is put into a state as described in FIG. 7.

S130 (see FIG. 5) is one example of a server process executing processing.

In S130, the session managing unit 210 executes the server processes generated in S122.

After S130, the processing proceeds to S141.

S141 is one example of a session termination message receiving processing.

In S141, the session managing unit 210 receives a session termination message transmitted from the operation terminal 120.

The session termination message is a message that requests disconnection of the interprocess communication between the server device and the client device, and disconnection of the interprocess communication in or between the server device(s).

After S141, the processing proceeds to S142.

S142 is one example of an interprocess communication disconnecting processing.

In S142, the session managing unit 210 disconnects the interprocess communication between the server processes connected in S123.

After S142, the processing proceeds to S143.

S143 is one example of a server process deleting processing.

In S143, the session managing unit 210 deletes the server processes generated in S122.

After S143, the processing proceeds to S144.

S144 is one example of an interprocess communication disconnecting processing.

In S144, the session managing unit 210 disconnects the interprocess communication between the server device 200 and the operation terminal 120.

After S144, the operation of the server device 200 is terminated.

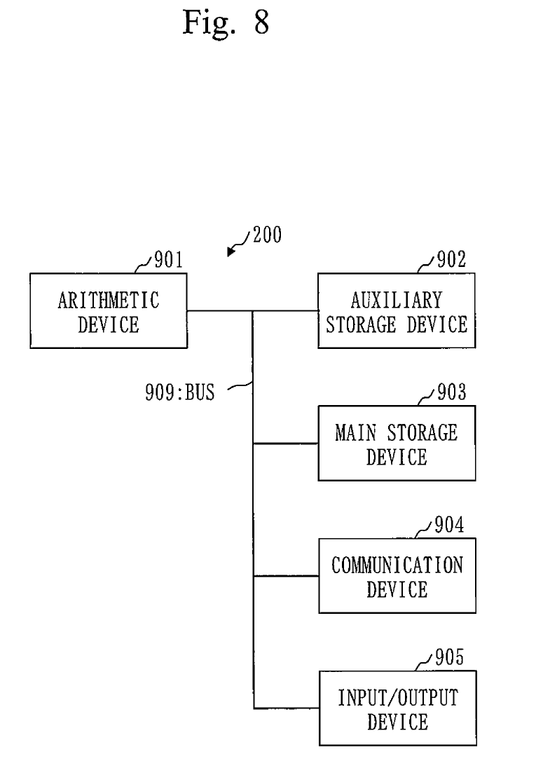

FIG. 8 is a diagram on hardware configuration of the server device 200 in the first embodiment.

The hardware configuration of the server device 200 in the first embodiment will be explained based on FIG. 8. However, the hardware configuration of the server device 200 may not be the same as the configuration described in FIG. 8.

The server device 200 is a computer equipped with an arithmetic device 901, an auxiliary storage device 902, a main storage device 903, a communication device 904 and an input/output device 905. The auxiliary storage device 902 is called a storage, and the main storage device 903 is called a memory.

The arithmetic device 901, the auxiliary storage device 902, the main storage device 903, the communication device 904 and the input/output device 905 connect to a bus 909.

The arithmetic device 901 is a CPU (Central Processing Unit) that executes programs.

The auxiliary storage device 902 is, for example, a ROM (Read Only Memory), a flash memory, or a hard disk drive.

The main storage device 903 is, for example, a RAM (Random Access Memory).

The communication device 904 performs wired or wireless communication via the Internet, a LAN (Local Area Network), a telephone network or other networks.

The input/output device 905 is, for example, a mouse, a keyboard, or a display device.

Programs are stored in the auxiliary storage device 902.

For example, an operating system (OS) is stored in the auxiliary storage device 902. Further, programs realizing the functions explained as “. . . units” are stored in the auxiliary storage device 902.

The programs are stored in the auxiliary storage device 902, loaded into the main storage device 903, read into the arithmetic device 901, and executed by the arithmetic device 901.

The information, data, files, signal values or variable values indicating the results of processing of decision, determination, extraction, detection, setting, registration, selection, generation, input and output, etc. are stored in the main storage device 903 or the auxiliary storage device 902.

### Explanation of Effects

In the first embodiment, the following effects are provided, for example.

The server device 200 is capable of executing a plurality of server programs designated by a client device in an associated manner.

By the connection between the server device 200 and the client device, it is possible to generate a session wherein a plurality of services are available.

In the data center, services are put into a state mutually usable.

A plurality of sessions for the plurality of server programs can be opened by the plurality of server programs being defined in the session start message 400. In this way, it is possible for the plurality of server programs to operate in a coordinated manner, and to offer high convenience to the users.

### Second Embodiment

It will be described an embodiment wherein the server device 200 executes an after-termination server program designated in a session termination message after disconnection of an interprocess communication between the server device and a client device.

Hereinafter, matters different from those in the first embodiment will be mainly described. The matters for which explanation is omitted are similar to those in the first embodiment.

### Explanation of Configuration

A configuration of the client server system 100 is similar to the configuration (see FIG. 1) explained in the first embodiment.

A function configuration of the server device 200 is similar to the function configuration (see FIG. 2) explained in the first embodiment. However, the session managing unit 210 and the server process executing unit 230 have functions as follows.

The session managing unit 210 receives a session termination message including an after-termination server program identifier, and disconnects an interprocess communication between the server device and the client device.

The after-termination server program identifier identifies the after-termination server program that is executed after the termination of the interprocess communication between the server device and the client device.

The server process executing unit 230 executes an after-termination server process after the interprocess communication between the server device and the client communication device is disconnected. The after-termination server process is a process of the after-termination server program identified by the after-termination server program identifier included in the session termination message.

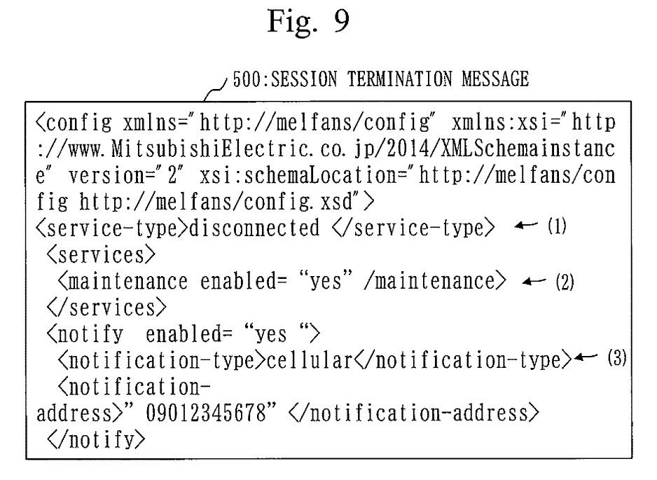

FIG. 9 is a diagram describing one example of a session termination message 500 in the second embodiment.

One example of the session termination message 500 in the second embodiment will be described based on FIG. 9.

The session termination message 500 includes lines of (1) through (3).

The line of (1) includes a string of “disconnected.” “disconnected” is a session termination identifier that means disconnection of the interprocess communication between the server device and the client device, and disconnection of an interprocess communication between the first server device and the second server device.

The line of (2) includes “maintenance” as a program identifier of the maintenance program 352. “maintenance” is one example of the after-termination server program identifier.

The line of (3) includes a string of “cellular.” “cellular” is one example of a notification method identifier that identifies a notification method to notify an execution result of a process of the maintenance program 352. “cellular” identifies a notification method of giving notice of the execution result to a mobile phone of a user.

### Explanation of Operations

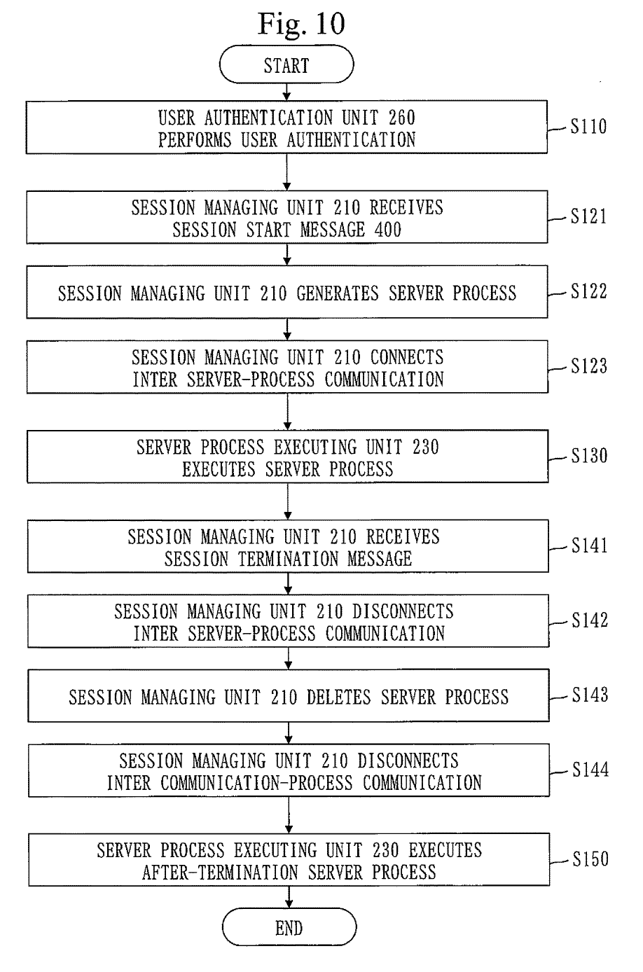

FIG. 10 is a flowchart describing operations of the server device 200 in the second embodiment.

The operations of the server device 200 in the second embodiment will be described based on FIG. 10. However, the operations of the server device 200 may not be the same as the operations described based on FIG. 10.

The processing from S110 through S144 is the same as the processing (see FIG. 5) described in the first embodiment.

After S144, the processing proceeds to S150.

S150 is one example of an after-termination server process execution processing and an execution result notification processing.

In S150, the session managing unit generates an after-termination server process and an execution context based on the session termination message 500. The generated execution context is a context for executing the after-termination server process, including a notification method identifier included in the session termination message 500.

The server process executing unit 230 executes the after-termination server program by executing an after-termination server process.

The server process executing unit 230 generates a notification message to give notice of the execution result of the after-termination server process, and performs notification of the notification message by the notification method, which is identified by the notification method identifier included in the execution context.

The after-termination server process is, for example, a process of the maintenance program 352. Then, the server process executing unit 230 detects an anomaly of the controller 112 as a result of monitoring the controller 112 in the factory 110 by executing the process of the maintenance program 352. Further, the notification method is a mobile phone.

In this case, the server process executing unit 230 generates an audio message for giving notice of the content of the detected anomaly as a notification message, and selects a mobile number of the user from the user management file 291. Then, the server process executing unit 230 selects from the user management file 291 the mobile number associated with a user identifier the same as the user identifier included in the execution context, connects to a mobile phone of the user using the mobile number, and transmits the audio message to the mobile phone of the user.

After S150, the operation of the server device 200 is terminated.

### Explanation of Effect

According to the second embodiment, an effect as follows, for example, is provided.

After disconnection of the interprocess communication between the server device and the client device, it is possible to execute the after-termination server program designated by the session termination message 500.

### Third Embodiment

An embodiment that reduces management burden of a shared key will be described.

Hereinafter, matters different from those in the first embodiment will be mainly described. The matters for which explanation is omitted are similar to those in the first embodiment.

### Explanation of Configuration

The configuration of the client server system 100 is similar to the configuration (see FIG. 1) described in the first embodiment.

The function configuration of the server device 200 is similar to the function configuration (see FIG. 2) described in the first embodiment.

However, the session managing unit 210 connects an interprocess communication between the server device and the client device over TLS. TLS is an abbreviation for Transport Layer Security.

Since a shared public key is generated by TLS, the shared secret key needs not be registered beforehand in the user management file 291. The shared secret key generated by TLS is stored in the server device 200 and the client device until the interprocess communication between the server device and the client device is disconnected.

A public key certificate used in TLS is stored beforehand in the server storing unit 290.

### Explanation of Operation

The operation of the server device 200 is similar to the operation (see FIG. 5) described in the first embodiment.

However, in S110, the session managing unit 210 connects an interprocess communication between the server device and the client device over TLS. Then, after a shared secret key is generated by TLS, user authentication is performed. A user identifier and a password included in an authentication request message is encrypted and decrypted with the shared secret key.

In the third embodiment, the server device 200 may execute an after-termination server process based on the session termination message 500 as in the second embodiment.

### Explanation of Effect

According to the third embodiment, an effect as follows, for example, will be provided.

The server device 200 needs not manage a shared secret key beforehand. In this way, it is possible to reduce the management burden of the shared secret key and warrant safety of the system.

Each embodiment is one example of embodiments of the client server system 100 and the server device 200.

That is, the client server system 100 and the server device 200 may not include a part of the composing elements described in each embodiment. Meanwhile, the client server system 100 and the server device 200 may be equipped with a composing element that is not described in each embodiment. Further, the client server system 100 and the server device 200 may be combinations of a part of or all of the composing elements in each embodiment.

The processing procedures described using the flowcharts and so on in each embodiment are one example of processing procedures of methods and programs related to each embodiment. The methods and programs related to each embodiment may be realized by processing procedures partially different from the processing procedures described in each embodiment.

The method related to each embodiment is an execution method of a server process, for example, and the program related to each embodiment is a server device program, for example.

In each embodiment, a “. . . unit” may be replaced with a “. . . processing,” a “. . . step,” a “. . . program,” a “. . . device,” etc.

### REFERENCE SIGNS LIST

100: client server system; 101: cloud; 102: wired network; 103: wireless network; 110: factory; 111: gateway device; 112: controller; 120: operation terminal; 200: server device; 201: server program storing unit; 202: data storing unit; 203: functional encryption cipher data; 204: functional public key; 210: session managing unit; 230: server process executing unit; 250: user authenticating unit; 260: key Managing unit; 290: server storing unit; 291: user management file; 300: server program group; 311: ERP analytics program; 321: product planning program; 322: mock-up program; 331: PLM program; 341: B-to-B program; 342: logistics program; 351:

simulation program; 352: maintenance program; 353: model based design program; 361: production management program; 362: SCADA program; 363: MES program; 371: first engineering program; 372: second engineering program; 373: third engineering program; 374: fourth engineering program; 375: fifth engineering program; 376: sixth engineering program; 377: seventh engineering program; 378: eighth engineering program; 380: session management program; 400: session start message; 500: session termination message; 901: arithmetic device; 902: auxiliary storage device; 903: main storage device; 904: communication device; 905: input/output device; 909: bus

1-8. (canceled)

9. A server device comprising:
a processor to execute a program; and
a memory to store the program which, when executed by the processor, results in performance of steps comprising,
receiving a session start message describing a dependency including a single service or a plurality of services to be used, from a client device,
generating processes of the single service or the plurality of services to be used, and a communication connection between the services, according to the session start message,
updating periodically a common key that protects a communication between the server device and the client device, and an interprocess communication on the sever device, provides the common key to the client device and the process,
and when either process in the session fails in a periodical key updating, deleting the session.

10. The server device as defined in claim 9, wherein
the program results in performance of steps comprising
maintaining a session even when the communication between the server device and the client device is disconnected.

11. The server device as defined in claim 10, wherein
a first execution context includes a public key to be used in a first server process.

12. The server device as defined in claim 11,
wherein the memory stores functional encryption data that is decrypted using a functional secret key as a secret key in a functional encryption method, and
wherein the program results in performance of steps comprising converting the functional encryption data into encryption data that is decrypted using the public key included in the execution context, by a re-encryption technique.

13. The server device as defined in claim 9, wherein
according to configuration information provided beforehand, a server process in the configuration information is started without a request from the client device.

14. A client device transmitting a session start message describing a dependency including the single service or the plurality of services to be used, to the server device as defined in claim 9.

15. A non-transitory computer readable medium storing a server device program to cause a computer to execute:
receiving a session start message describing a dependency including a single service or a plurality of services to be used, from a client device to a server device,
generating processes of the single service or the plurality of services to be used, and a communication connection between the services, according to the session start message,
updating step to update periodically a common key that protects a communication between the server device and the client device, and an interprocess communication on the sever device, provides the common key to the client device and the process,
and when either process in the session fails in a periodical key updating, deleting the session.

16. A session managing method comprising:
receiving a session start message describing a dependency including single service or a plurality of services to be used, from a client device;
generating processes of the single service or the plurality of services to be used, and a communication connection between the services, according to the session start message;
updating periodically a common key that protects the communication between a server device and the client device, and an interprocess communication on the sever device, provides the common key to the client device and the process;
and when either process in the session fails in a periodical key updating, deleting the session.

17. A client server system comprising a client device and a server device, wherein
the server device receives a session start message describing a dependency including a single service or a plurality of services to be used, from a client device,
generates processes of the single service or the plurality of services to be used, and a communication connection between the services, according to the session start message,
updates periodically a common key that protects the communication between the server device and the client device, and an interprocess communication on the sever device, provides the common key to the client device and the process,
and when either process in the session fails in a periodical key updating, deletes the session.
